(19) United States
(12) Patent Application Publication
(10) Pub. No.: US 2022/0399599 A1
(43) Pub. Date: Dec. 15, 2022

(54) FLEXIBLE LITHIUM-ION BATTERY AND METHOD OF MANUFACTURING THEREOF

(71) Applicant: LIONROCK BATTERIES LIMITED, Hong Kong (HK)

(72) Inventor: Man Yung David YEUNG, Hong Kong (HK)

(21) Appl. No.: 17/348,119

(22) Filed: Jun. 15, 2021

(51) Int. Cl. H01M 50/105; H01M 10/0585; H01M 50/136; H01M 50/547; H01M 50/44; H01M 50/211

(52) U.S. Cl. CPC H01M 50/105; H01M 10/0585; H01M 50/136; H01M 50/547; H01M 50/44; H01M 50/211

(57) ABSTRACT

The disclosure provides a flexible and rechargeable battery unit that is configured to a free-form shape, and/or configured to include uneven thickness, thereby providing multi-axial coverage and/or enhanced bendability and storage capacity. The battery unit and method for fabricating the battery unit includes cathode and anode substrates configured in a free-form shape, a separator layer made from a nanofiber material for enclosing either the cathode substrate or the anode substrate to form an enclosed cathode substrate or enclose anode substrate, with the enclosed cathode substrate being overlapped with the anode substrate, or the enclosed anode substrate being overlapped with the cathode substrate to form a stacked battery structure, which can be further configured to form a notched battery structure. The stacked battery structure or the notched battery structure, which can be expanded, is subsequently injected with an electrolyte and closed using a packaging layer to form a battery pouch structure.

### FIELD OF THE DISCLOSURE

The present disclosure generally relates to a flexible and rechargeable battery and a method for fabricating the same, and particularly to a flexible nanofiber-based lithium-ion battery of a free-form shape (unconventional pattern) and/or uneven thickness to provide multi-axial coverage and/or enhanced bendability and storage capacity.

### BACKGROUND OF THE DISCLOSURE

Conventional non-flexible batteries, which have rigid cells for outer protection, are generally designed compactly and made thick for more energy storage. In other words, conventional non-flexible batteries, which are rigid and typically coin-shaped, rectangular or cylindrical to conform with the industry standard, are neither designed and nor made for bendability. Indeed, the industry's standard production equipment that deposits separators between electrodes by way of winding or zig-zag folding, constrains and limits conventional batteries to the typical coin-shape, rectangular or cylindrical shapes. Also, the separators in the conventional batteries that are laid between positive (+ve) and negative (−ve) terminals are expected to remain static and therefore not elastic. When a bending movement is encountered, the position of the electrodes or separators in the conventional batteries may shift, break and/or cause a short circuit hazard.

Conventional flexible batteries, on the other hand, can help to resolve various constraints and limitations that occur in conventional non-flexible batteries, and as a result such is increasingly used in smart wearables, internet of things, health care products, medical devices and smart cards. Still, the conventional flexible batteries, which use elastic separators, have constraints or limitations on bendability in allowing only certain degree of movement (bending) before confronting the risk of breaking or causing a short circuit. For instance, when the elastic separators are placed between positive and negative electrodes using the conventional methods of rolling/winding/zig-zag folding, the elastic separators may still shift after the bending movement has occurred. The inelastic outer packaging (usually made of aluminum-based film) of batteries also constrains degree of bending, especially when battery is thick where outer radius and inner radius have much difference, and limits the battery shape to that of cylindrical and/or rectangular.

More specifically, despite the elastic nature of the separators, the conventional separator disposition method further limits the battery structure to a cylindrical shape (i.e., via rolling method), which is completely rigid, or a rectangular shape (i.e., via zig-zag folding method) which is only slightly more bendable than the cylindrical shape when the thickness is below 2 mm. Still, neither the cylindrically shaped battery nor the rectangularly shaped battery can fully cover multi-axial curved surfaces. For instance, the rectangularly shaped battery that bends only in one axial direction cannot smoothly cover or fit over a rounded object that requires bending in at least two axial directions without causing, e.g., protruding corners or wrinkles.

Therefore, there is a need for a lithium-ion based rechargeable battery that is safe to operate and highly bendable without being constrained to a particular battery shape (e.g., cylindrical or rectangular), or subjected to a risk of the separator shifting when encountering a movement (e.g., bending, stretching or twisting), while maintaining the battery's charge/discharge property, and benefiting from the battery's free-form configuration.

### SUMMARY OF THE DISCLOSURE

It is therefore an objective of the present disclosure to provide a nanofiber-based lithium-ion battery unit that is of a free-form shape (unconventional pattern) to allow multi-axial coverage.

It is another objective of the present disclosure to provide the nanofiber-based lithium-ion battery unit that is of an uneven thickness to allow enhanced bendability and storage capacity.

In order to solve the above-mentioned problems of the conventional technology, and to achieve the above-mentioned objectives, an aspect of the present disclosure provides a cathode substrate configured in a free-form shape having a positive current collector integrated within positive electrodes; an anode substrate configured in the free-form pattern having a negative current collector integrated within negative electrodes; and a separator layer for enclosing the cathode substrate or the anode substrate to form an enclosed cathode substrate or an enclosed anode substrate, wherein the enclosed cathode substrate overlaps with the anode substrate, or the enclosed anode substrate overlaps with the cathode substrate to form a stacked battery structure in the free-form shape.

To proceed further, a battery pouch structure in the free-form shape is formed by wrapping the stacked battery structure with a packaging layer, wherein the battery pouch structure is securely closed after an electrolyte is added into the battery pouch structure. A positive terminal that extends outwardly from the battery pouch structure is connected to the positive current collector, and a negative terminal that extends outwardly from the battery pouch structure is connected to the negative current collector.

Optionally, the battery unit can include one or more duplicates of the stacked battery structure that are placed in an overlapping manner with the stacked battery structure to form an enlarged stacked battery structure in the free-form shape. By wrapping the enlarged stacked battery structure with a packaging layer, an enlarged battery pouch structure in the free-form shape is formed, which is then securely closed after an electrolyte is added into the enlarged battery pouch structure.

Alternatively, a notched battery structure can be further formed by configuring the stacked battery structure to include uneven thickness. The notched battery structure is then used to form a battery pouch structure of uneven thickness by wrapping it with a packaging layer. It is noted that the battery pouch structure of uneven thickness is securely closed after an electrolyte is added into the battery pouch structure. It is also noted that a positive terminal that extends outwardly from the battery pouch structure is connected to the positive current collector, and a negative terminal that extends outwardly from the battery pouch structure of the second type is connected to the negative current collector.

It is preferred that the separator layer is constructed from a nanofiber material with elastic property and the packaging layer is made from an aluminum material. It is also preferred that the complete or effective sealing of the packaging layer is performed using a laser or thermal sealing tool, and closed or sealed by way of tracing, cutting and shape sealing procedures.

In a first exemplary embodiment, the cathode and anode substrates are configured in a free-form shape of, e.g., helmet-like, crisscross or letter-E pattern, thereby producing a stacked battery structure of the free-form pattern that is bendable in two or more axial directions. In a second exemplary embodiment, the stacked battery structure of the free-form pattern is configured to have an uneven thickness by folding inward at least one end of the stacked battery structure. As a result, one or more thinner sections of the configured structure provide additional bendability, and one or more thicker sections of the configured structure provide additional charge/discharge capacity.

Another aspect of the present disclosure is to provide a method for fabricating a flexible and rechargeable battery unit that is consisted of forming a cathode substrate configured in a free-form shape which has a positive current collector placed within positive electrodes; forming an anode substrate configured in the free-form shape by placing a negative current collector within negative electrodes; enclosing the cathode substrate or the anode substrate using a separator layer to form an enclosed cathode substrate or an enclosed anode substrate, wherein the enclosed cathode substrate overlaps with the anode substrate, or the enclosed anode substrate overlaps with the cathode substrate to form a stacked battery structure.

The next step involves forming a battery pouch structure of the free-form shape by wrapping the stacked battery structure with a packaging layer, wherein the battery pouch structure of the free-form shape is securely closed after an electrolyte is added into the battery pouch structure. A positive terminal that extends outwardly from the battery pouch structure of the first type is connected to the positive current collector, and a negative terminal that extends outwardly from the battery pouch structure is connected to the negative current collector.

Optional steps involve placing one or more duplicates of the stacked battery structure in an overlapping manner with the stacked battery structure to form an enlarged stacked battery structure in the free-form shape, and forming an enlarged battery pouch structure of the free-form shape by wrapping the enlarged stacked battery structure with a packaging layer, wherein the enlarged battery pouch structure of the free-form shape is securely closed after an electrolyte is added into the enlarged battery pouch structure.

Alternative steps can include forming a notched battery structure by configuring the stacked battery structure to include uneven thickness; and forming a battery pouch structure of uneven thickness by wrapping the notched battery structure with a packaging layer, wherein the notched battery pouch structure is completely or securely closed or sealed after an electrolyte is added into the battery pouch structure of the second type. It is noted that the battery pouch structure of uneven thickness is completely or effectively closed or sealed after an electrolyte is added into the battery pouch structure. It is also noted that in a positive terminal that extends outwardly from the battery pouch structure is connected to the positive current collector, and a negative terminal that extends outwardly from the battery pouch structure is connected to the negative current collector.

In the method for fabricating the flexible and rechargeable battery unit, it is preferred that the separator layer is constructed from a nanofiber material with elastic property and the packaging layer is made from an aluminum material. It is also preferred that the sealing of the packaging layer is performed using a laser or thermal sealing tool, and closed or sealed by way of tracing, cutting and shape sealing procedures.

In a first exemplary embodiment for the method of fabricating the flexible and rechargeable battery unit, the cathode and anode substrates are configured in a free-form shape of, e.g., helmet-like, crisscross or letter-E pattern, thereby producing a stacked battery structure of the free-form pattern that is bendable in two or more axial directions. In a second exemplary embodiment for the method of fabricating the flexible and rechargeable battery unit, the stacked battery structure of the free-form pattern is configured to have an uneven thickness by folding inward at least one end of the stacked battery structure. As a result, one or more thinner sections of the configured structure provide additional bendability, and one or more thicker sections of the configured structure provide additional charge/discharge capacity.

Compared with the related art, the present disclosure supports a nanofiber-based lithium-ion battery unit that is highly bendable while maintaining a stable and safe battery storage and operation. Specifically, the battery unit is configured in a free-form shape which is of an unconventional pattern to enable multi-axial coverage. Additionally, the battery unit is configured to include an uneven thickness that enhances bendability and storage capacity.

### BRIEF DESCRIPTION OF THE DRAWINGS

Additional features and advantage of the present disclosure will be made apparent from the following detailed description of one or more exemplary embodiments with reference to the accompanying figures, which are given for illustrative purpose only, and thus are not limitative of the present disclosure, wherein:

FIG. 1 is an illustrative diagram showing a first exemplary battery unit of a first free-form configuration according to a first exemplary embodiment of the present disclosure;

FIG. 2 is an illustrative diagram showing a second exemplary battery unit of a second free-form pattern according to a second exemplary embodiment of the present disclosure;

FIG. 3 is a schematic diagram showing a first stacked battery structure according to the first exemplary embodiment of the present disclosure;

FIG. 4 is a schematic diagram showing a second stacked battery structure according to the first exemplary embodiment of the present disclosure;

FIG. 5 is a schematic diagram showing a third stacked battery structure according to the first exemplary embodiment of the present disclosure;

FIG. 6 is a schematic diagram showing a first battery pouch structure according to the first exemplary embodiment of the present disclosure;

FIG. 7 is a schematic diagram showing a second battery pouch structure according to the first exemplary embodiment of the present disclosure;

FIG. 8 is an illustrative diagram showing a cathode substrate in a third free-form (crisscross) pattern according to the first exemplary embodiment of the present disclosure;

FIG. 9 is an illustrative diagram showing a separator with the cathode substrate in the crisscross pattern according to the first exemplary embodiment of the present disclosure;

FIG. 10 is an illustrative diagram showing an enclosed cathode structure in the crisscross pattern according to the first exemplary embodiment of the present disclosure;

FIG. 11 is an illustrative diagram showing an anode substrate in the crisscross pattern according to the first exemplary embodiment of the present disclosure;

FIG. 12 is an illustrative diagram showing a stacked battery structure in the crisscross pattern according to the first exemplary embodiment of the present disclosure;

FIG. 13 is an illustrative diagram showing an expanded stacked battery structure in the crisscross pattern according to the first exemplary embodiment of the present disclosure;

FIG. 14 is an illustrative diagram showing a packaging layer with the stacked battery structure in the crisscross pattern according to the first exemplary embodiment of the present disclosure;

FIG. 15 is an illustrative diagram showing a battery pouch structure in the crisscross pattern according to the first exemplary embodiment of the present disclosure;

FIG. 16 is an illustrative diagram showing the battery pouch structure in the crisscross pattern in the first embodiment converting to a second exemplary embodiment of the present disclosure;

FIG. 17 is an illustrative diagram showing top and side views of a first notched battery structure according to the second exemplary embodiment of the present disclosure;

FIG. 18 is an illustrative diagram showing a packaging layer with the first notched battery structure according to the second exemplary embodiment of the present disclosure;

FIG. 19 is an illustrative diagram showing top and side views of a first battery pouch structure according to the second exemplary embodiment of the present disclosure;

FIG. 20 is an illustrative diagram showing a separator with a cathode substrate in a fourth free-form (letter-E) pattern according to the first exemplary embodiment of the present disclosure;

FIG. 21 is an illustrative diagram showing an enclosed cathode structure in the letter-E pattern according to the first exemplary embodiment of the present disclosure;

FIG. 22 is an illustrative diagram showing an anode substrate in the letter-E pattern according to the first exemplary embodiment of the present disclosure;

FIG. 23 is an illustrative diagram showing a stacked battery structure in the letter-E pattern according to the first exemplary embodiment of the present disclosure;

FIG. 24 is an illustrative diagram showing the stacked battery structure in the letter-E pattern in first embodiment converting to a second exemplary embodiment of the present disclosure;

FIG. 25 is an illustrative diagram showing top and side views of a second notched battery structure according to the second exemplary embodiment of the present disclosure;

FIG. 26 is an illustrative diagram showing a packaging with the second notched battery structure according to the second exemplary embodiment of the present disclosure; and

FIG. 27 is an illustrative diagram showing top and side views of a second battery pouch structure according to the second exemplary embodiment of the present disclosure.

### DETAILED DESCRIPTION OF THE EXEMPLARY EMBODIMENTS

One or more exemplary embodiments according to the present disclosure directed to a battery unit will be described below with references to the accompanying figures. It should be understood that the figures are not depicted to scale.

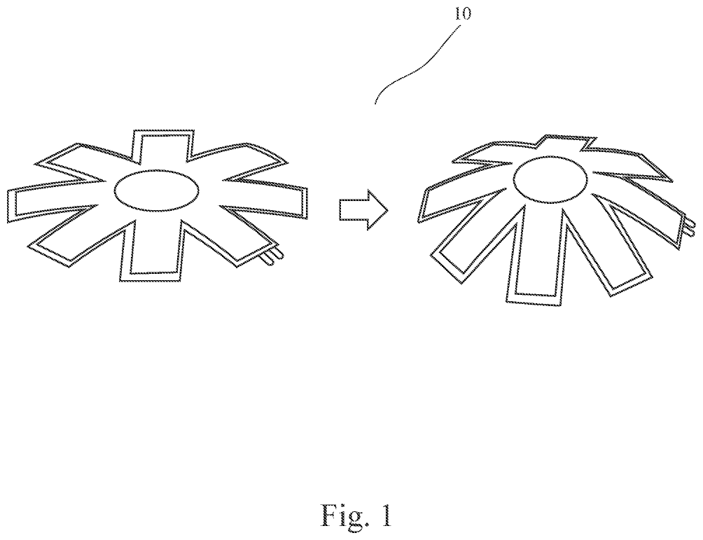

In FIG. 1, a first battery unit 10 with a first free-form shape (i.e., a helmet-like pattern) according to a first exemplary embodiment (i.e., even thickness) is illustrated. Specifically, the battery unit 10 is shaped in the helmet-like pattern to allow bending in multiple axial directions, thereby eliminating and solving issues in the conventional art on protruding corners or wrinkles when covering or contouring over an object having multi-axial curved surfaces. The transformation of the battery unit 10 from a non-bending mode to a bending mode is shown in FIG. 1 to illustrate the multi-axial bending. The shape or pattern of the battery unit 10 is not limited to the example as shown FIG. 1 since such can be of any particular shape or configuration (i.e., free-form shape).

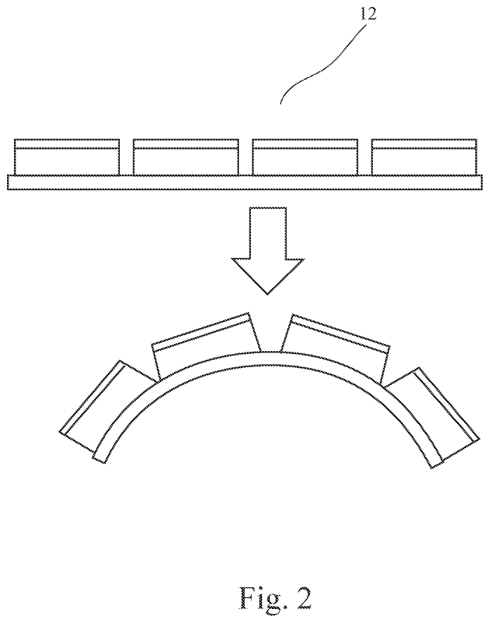

FIG. 2 shows a second battery unit 12 in a second free-form pattern according to a second exemplary embodiment (i.e., uneven thickness). The thinner sections of the notched battery structure 12 provide additional bendability, and the thicker sections of the notched battery structure 12 provide additional charge/discharge capacity. The enhanced bendability of the battery unit 12 is illustrated in FIG. 2 by contrasting the battery unit 12 in a bending mode from a non-bending mode.

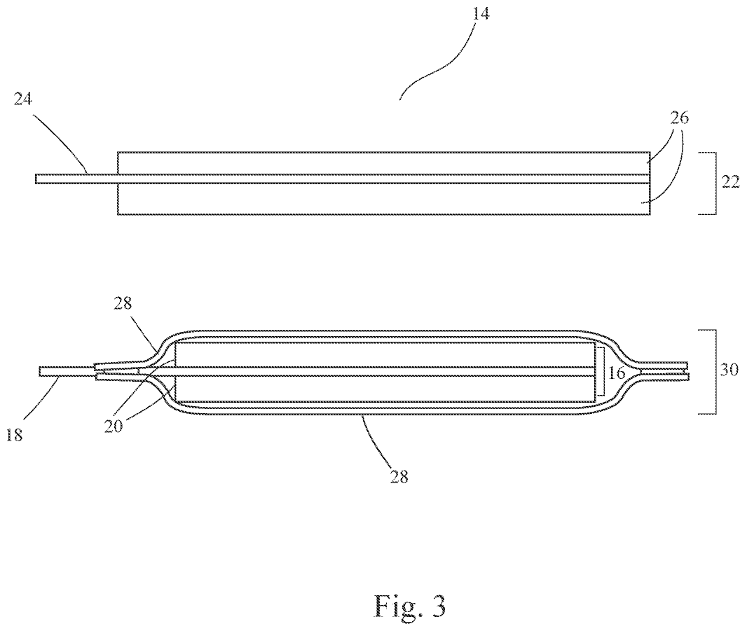

Referring to FIG. 3, a first stacked battery structure 14 according to the first exemplary embodiment of the present disclosure is shown. In the stacked battery structure 14, a cathode substrate 16 has a positive current collector 18 integrated within positive (+ve) electrodes 20, and the anode substrate 22 has a negative current collector 24 integrated within negative (−ve) electrodes 26. The cathode substrate 16 is further enclosed (covered and encapsulated) by a separator layer 28, and subsequently closed or sealed by way of, e.g., tracing, cutting and shape sealing procedures to form an enclosed cathode substrate 30. One end of the positive current collector 18 extends outward from the enclosed cathode substrate 30, and one end of the negative current collector 24 extends outward from negative electrodes 26. The anode substrate 22 is aligned and stacked with enclosed cathode substrate 30 by way of an overlapping manner to form the stacked battery structure 14, with the positive current collector 18 placed on the same side as the negative current collector 24.

The separator layer 28 the present disclosure is selected and made from a nanofiber material for its structure (e.g., woven mesh) and property (e.g., elasticity). The resulting nanofiber separator can be bent, deformed and/or stretched without breaking. The enclosed structure encapsulated by the nanofiber separator, which has an elongation-at-break ratio of over 25% to ensure the enclosed structure to remain intact when the electrodes are bending or deformed, and allows the electrodes to remain within the enclosed structure. In other words, the nanofiber separator, which is consisted of a polymer mesh and elastic structure that has over 25% in elongation-at-break ratio, can provide a safe and stable operation by allowing the enclosed structure to remain intact when the electrodes are bended or deformed. As a result, the nanofiber separator is much superior to the conventional separator made from a polymer sheet with holes, which can break when bent or stretched, thereby causing a short circuit. Also, the use of nanofiber separator as the separator layer 28 allows for any battery unit in the first embodiment to be configured into the free-form shape, and any battery unit in the second embodiment to be configured to have uneven thickness.

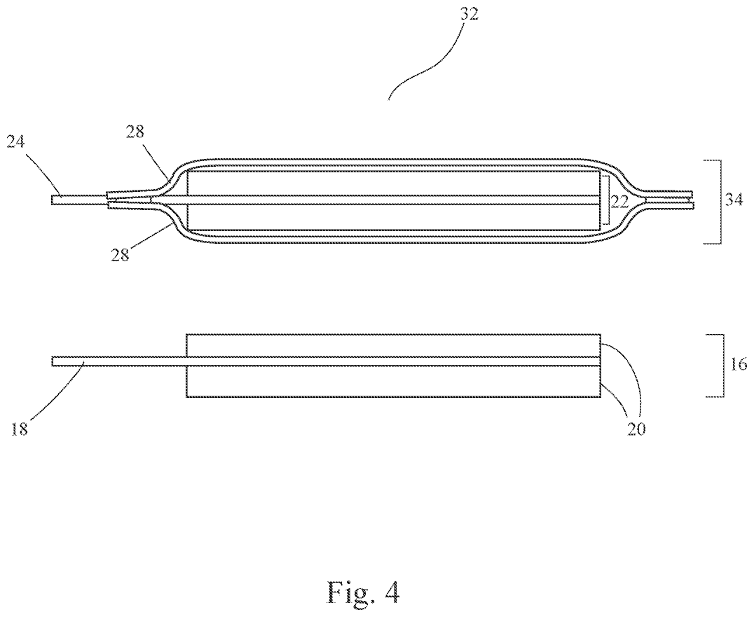

A second stacked battery structure 32 according to the first exemplary embodiment is shown in FIG. 4. Specifically, instead of enclosing the cathode 20, the anode substrate 22 is now enclosed (covered and encapsulated) by the separator layer 28, and then completely or effectively closed or sealed by way of, e.g., tracing, cutting and shape sealing procedures to form an enclosed anode substrate 34.

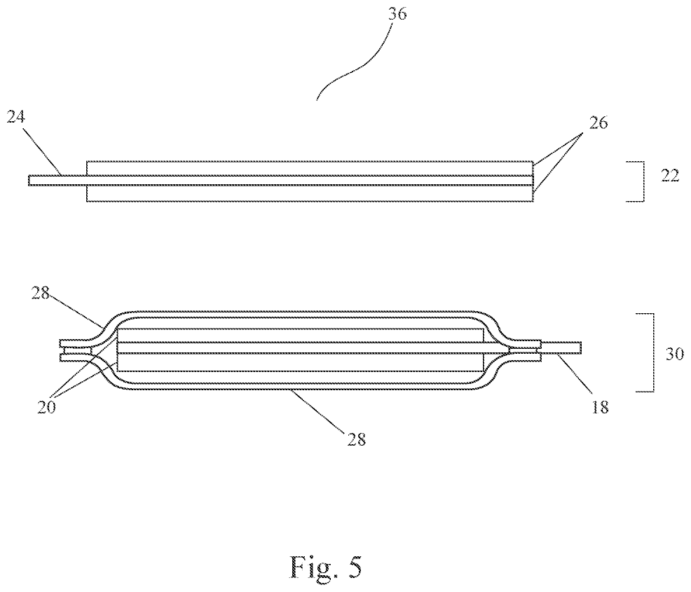

FIG. 5 shows a third stacked battery structure 36 that has the protruding ends of the positive current collector 18 and the negative current collector 24, respective, placed on the opposite sides relative to each other. Similar to the first stacked battery structure 14, the third stacked battery structure 36 aligns the anode substrate 22 with the enclosed cathode substrate 30 in an overlapping manner.

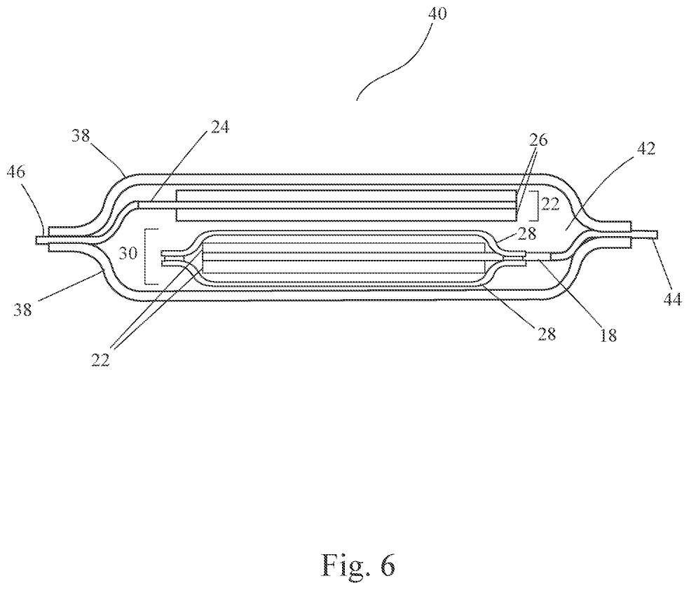

Turning to FIG. 6, the third stacked battery structure 36 as shown in FIG. 5 is wrapped (covered and laminated), and then completely or effectively closed or sealed by a packaging layer 38 to form a first battery pouch structure 40 according to the first exemplary embodiment. An intermittent sealing method (e.g., with small open packets) can be implemented as an effective sealing method relative to the complete sealing of the packaging layer 38 by safely retaining an electrolyte 42 within the first battery pouch structure 40. Prior to completely or effectively enclosing or sealing the first battery pouch structure 40 using the packaging layer 38 by way of, e.g., tracing, cutting and shape sealing procedures, the electrolyte 42 is added or injected therein. The injected electrolyte 42 filled the cavity of the first battery pouch structure 40 enclosed by the packaging layer 38. Also, one end of the positive current collector 18 is connected to a positive terminal 44, which extends outward from the first battery pouch structure 40. Similarly, one end of the negative current collector 24 is connected to a negative terminal 46, which also extends outward from the first battery pouch structure 40. The 38 can be constructed from a flexible aluminum material, such as an aluminum foil or sheet.

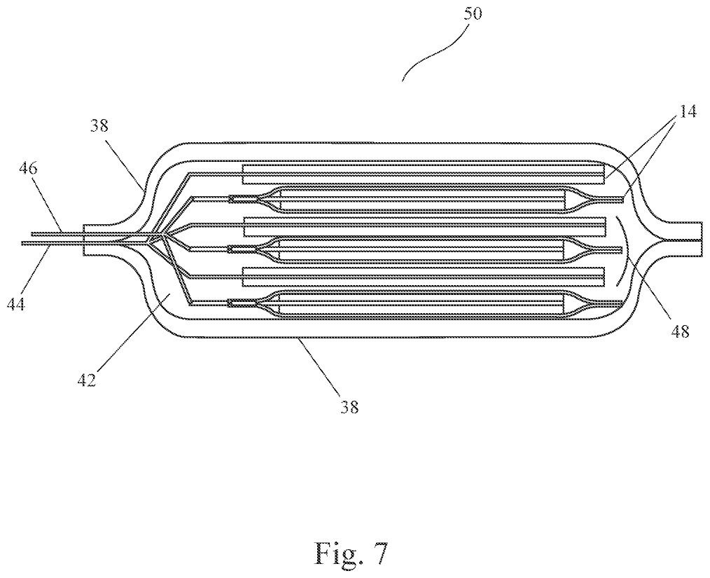

FIG. 7 illustrates an optional arrangement to which two additional duplicates of the stacked battery structure 14 as shown in FIG. 3 are aligned and stacked with the stacked battery structure 14 in an overlapping manner to form an expanded stacked battery structure 48. In other words, each of the duplicates that is of the same structure as the stacked battery structure 14 as shown in FIG. 3 is further aligned and stacked in a direct overlapping manner with the stacked battery structure 14 to form the expanded stacked battery structure 48 of the first exemplary embodiment. The expanded stacked battery structure 48 is further wrapped and completely or effectively closed or sealed by the packaging layer 38 to form a second battery pouch structure 50 according to the first exemplary embodiment. In particular, prior to completely or effectively sealing the expanded battery pouch structure 48 by way of, e.g., tracing, cutting and shape sealing procedures using the packaging layer 38, the electrolyte 42 is added or injected into the expanded battery pouch structure 48 to filled the cavity of the second battery pouch structure 50 enclosed by the packaging layer 38.

In FIG. 7, each positive current collector from each stacked battery structure 14 and duplicates thereof is connected to the positive terminal 44, which extends outward from the second battery pouch structure 50. Likewise, each negative current collector from each stacked battery structure 14 and duplicates thereof is connected to the negative terminal 46, which extends outward from the second battery pouch structure 50.

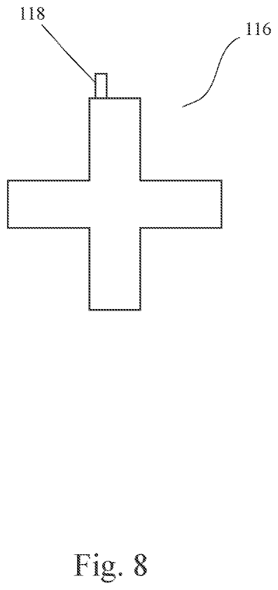

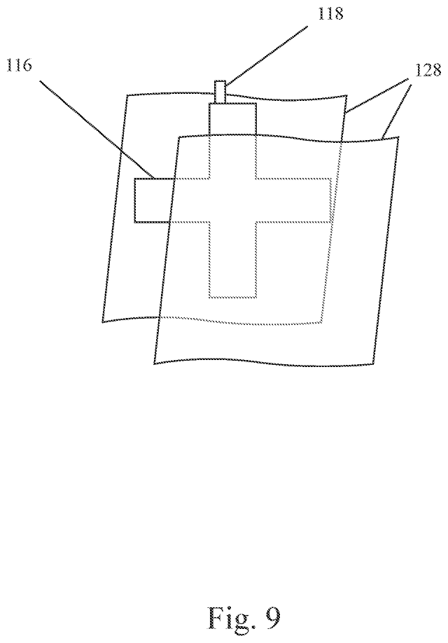

FIG. 8 shows a cathode substrate 116 of a third free-form shape (“crisscross pattern”) according to the first exemplary embodiment of the present disclosure. The cathode substrate 116 has a positive current collector 118 with one end thereof extending or protruding outward therefrom at one end thereof. A further enclosure (i.e., covering and encapsulating along with the subsequent sealing thereof) of the cathode substrate 116 by the separator layer 128 is illustrated in FIG. 9. The separator layer 128 is made from a nanofiber fiber material and sufficiently sized to cover the cathode substrate 116. The enclosing of the cathode substrate 116 by the separator layer 128 can be completed through e.g., tracing, cutting and shape sealing procedures.

Specifically, as with the separator layer 28 referenced in FIG. 3-5, the nanofiber separator layer 128 as shown in FIG. 9 is made from a woven mesh structure and flexible, and contains mechanical properties of a polymer. The polymeric properties and mesh structure allow the nanofiber separator layer 128 have superior characteristics over a conventional separator, which is generally made of a sheet with holes therein. As a result, whereas the conventional separator can break when deformed causing a short circuit, the nanofiber separator used in the battery unit of the present disclosure is stable and safe to use with no risk to cause the short circuit.

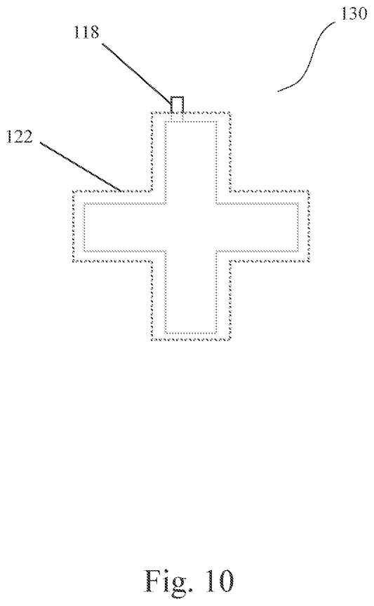

Referring to FIG. 10, the cathode substrate 116 of the crisscross pattern, after being covered by the separator layer 128, is traced, cut and shape sealed along a dashed or dotted line 122, resulting in an enclosed cathode substrate 130 of the crisscross pattern. The tracing, cutting and shape sealing procedures can be accomplished by, e.g., a laser or shaped thermal sealing machinery. One end of a positive current collector 118 extends or protrudes outward from the dashed line 122. The complete sealing of the entire boundary within the dashed line 122 can be replaced with other effective methods, such as a having a small space between fusing points, as long as the electrode is trapped or secured inside the sealing boundary, and thus remain separated from the other electrode stacked that is located above or underneath.

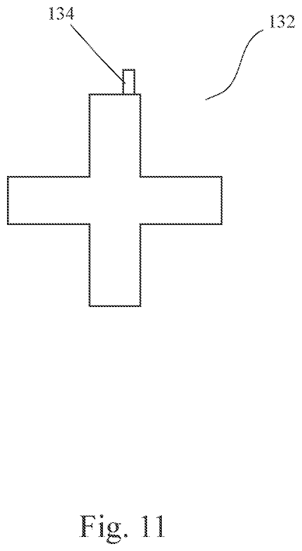

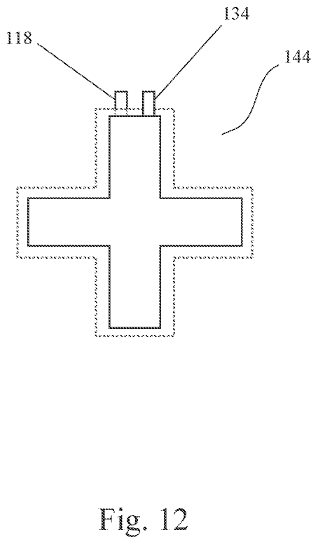

In FIG. 11, an anode substrate 132 of the crisscross pattern is illustrated, with one end of a negative current collector 134 extending or protruding outward therefrom at one end thereof. In FIG. 12, a stacked battery structure 144 of the crisscross pattern is formed by stacking the enclosed cathode substrate 130 as shown in FIG. 10 with the anode substrate 132 as shown in FIG. 11. The stacking is achieved by a direct overlapping of the enclosed cathode substrate 130 to the anode substrate 132. The ends of the positive current collector 118 and negative current collector 134 are respectively positioned on the same side, and protruding outward from the stacked battery structure 144.

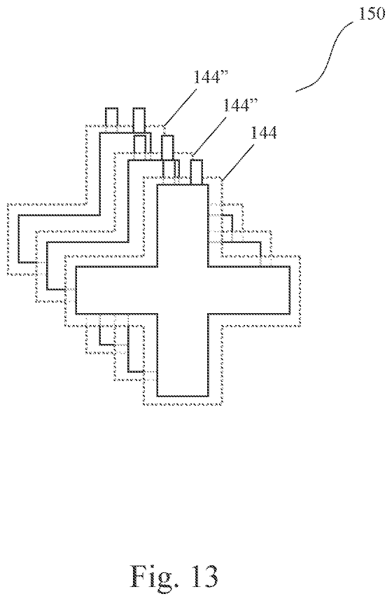

Optionally, by duplicating the stacked battery structure 144 a number of times (i.e., N times), further stacking of the duplicated structures 144′ and 144″ of the stacked battery structure 144 can be performed as shown in FIG. 13. Specifically, an expanded stacking can be made by using the additional structures 144′ and 144″, which are the duplicates of the stacked battery structure 144 as shown in FIG. 12. In other words, the duplicated structures 144′ and 144″ are made in the same manner as the stacked battery structure 144, and a direct overlapping is made to form an expanded stacked battery structure 150 of the crisscross pattern as illustrated in FIG. 13.

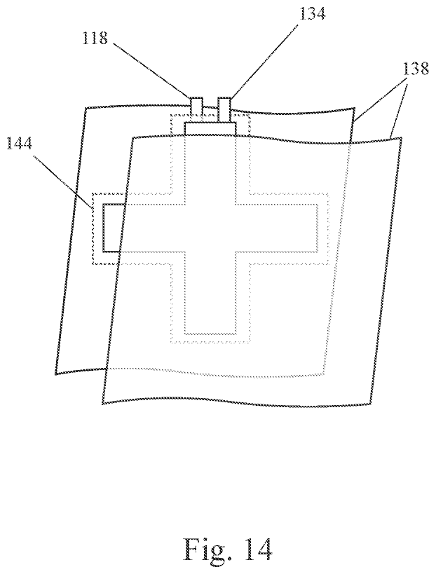

In FIG. 14, the stacked battery structure 144 of the crisscross pattern as shown in FIG. 12 is further wrapped and subsequently closed or sealed through a packaging layer 138, which can be constructed from a flexible aluminum material, such as an aluminum foil or sheet. It is noted that the packaging layer 138 is sufficiently sized to cover the stacked battery structure 144, and that electrolyte 42 is added or injected prior to the stacked battery structure 144 being completely or effectively closed and sealed by way of, e.g., tracing, cutting and shape sealing procedures.

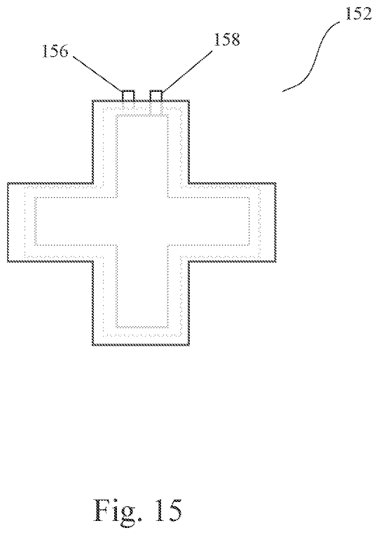

A battery pouch structure 152 of the crisscross pattern as shown in FIG. 15 is formed by wrapping and sealing of the packaging layer 138 to the stacked battery structure 144. One end of the positive current collector 118 is connected to the positive terminal 156, which extends outward therefrom at one end of the second battery pouch structure 152. Similarly, one end of the negative current collector 134 is connected to the negative terminal 158, which extends outward therefrom at the same end of the battery pouch structure 152 of the crisscross pattern.

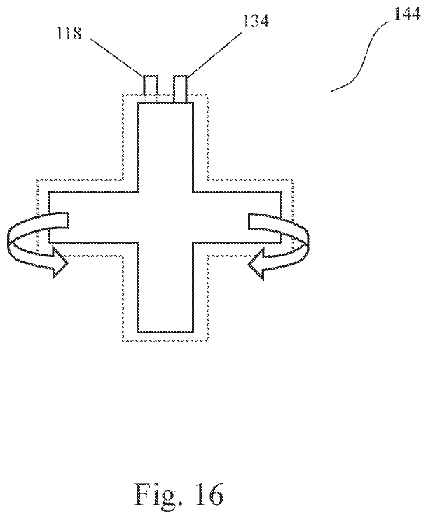

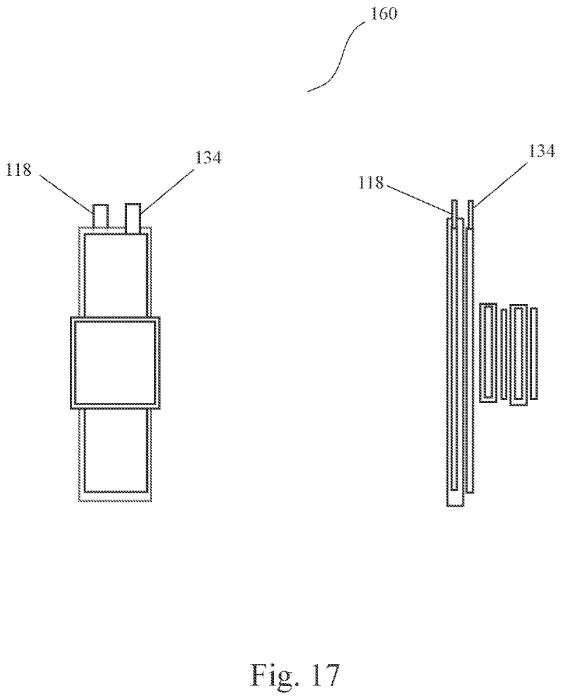

In FIG. 16, the stacked battery structure 144 of the crisscross pattern as shown in FIG. 12 according to the first embodiment is configured (e.g., folded or bended inward) to form a first notched battery structure 160 of uneven thickness according to a second exemplary embodiment as shown in FIG. 17. More specifically, FIGS. 16 and 17 together illustrate a process at which least one end or opposite ends of the stacked battery structure 144 are configured by, e.g., bending or folding inward to create an uneven thickness on the first notched battery structure 160. As a result, a thinner section of the first notched battery structure 160 provides additional bendability, while a thicker section of the first notched battery structure 160 provides additional charge/discharge capacity. Such uneven thickness is depicted in top and side views of the first notched battery structure 160 as shown in FIG. 17.

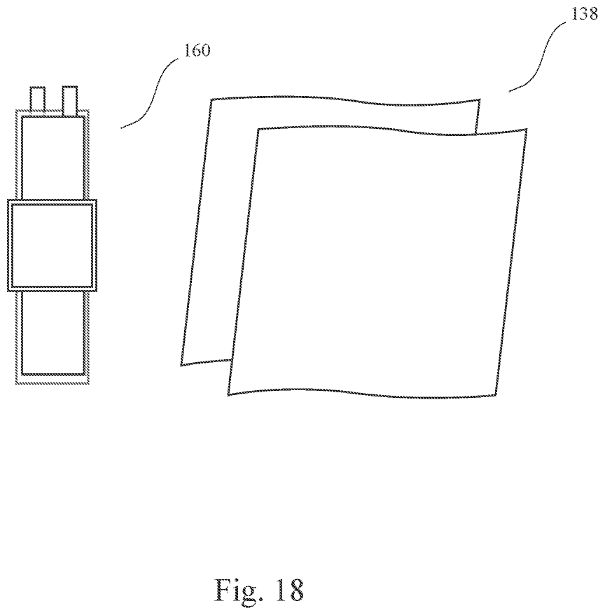

As with the first embodiment, the first notched battery structure 160 of the second embodiment as shown in FIG. 18 is further wrapped and subsequently closed or sealed through the packaging layer 138, which is sufficiently sized to cover the first notched battery structure 160. Particularly, the electrolyte 42 is added or injected prior to the first notched battery structure 160 being completely or effectively sealed or closed by way of, e.g., tracing, cutting and shape sealing procedures.

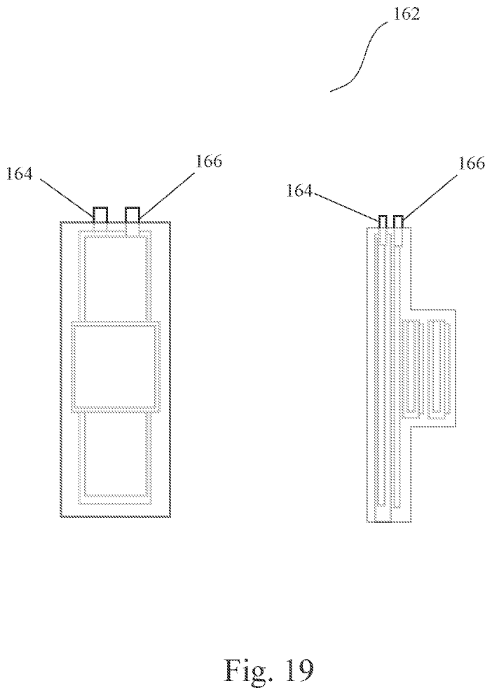

A second battery pouch structure 162 according to the second embodiment is shown in FIG. 19. The second battery pouch structure of uneven thickness is formed by completely or effectively enclosing and sealing the packaging layer 138 to the first notched battery structure 160. One end of the positive current collector 118 connected to a positive terminal 164, which extends outward therefrom at one end of the second battery pouch structure 162. Similarly, one end of the negative current collector 134 is connected to a negative terminal 166, which extends outward therefrom at the same end of the second battery pouch structure 162.

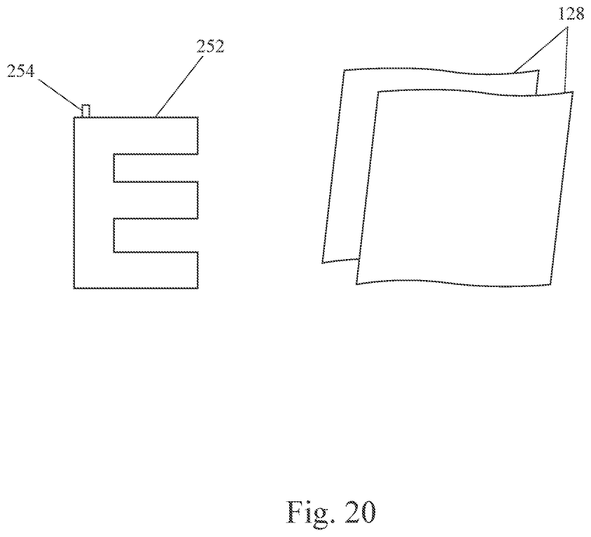

In FIG. 20, a cathode substrate 252 in a fourth free-form shape (“letter-E pattern”) according to the first exemplary embodiment of the present disclosure is shown along with the separator layer 128. Specifically, the cathode substrate 252 of the letter-E pattern with one end of a positive current collector 254 extending or protruding outward therefrom at one end thereof is shown, and such is subsequently enclosed by the separator layer 128 that is sufficiently sized to cover the cathode substrate 252. The complete or effective enclosing or sealing of the cathode substrate 252 using the separator layer 128 can be completed through e.g., tracing, cutting and shape sealing procedures.

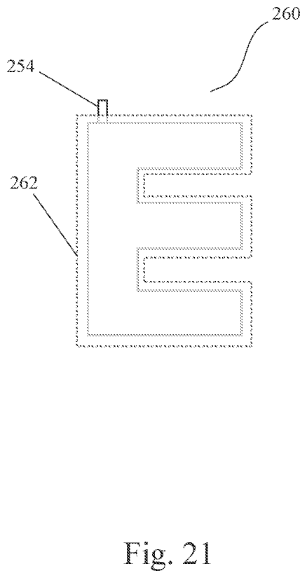

In FIG. 21, an enclosed cathode substrate 260 of the letter-E pattern is formed by enclosing and sealing of the cathode substrate 252 using the separator layer 128. Specifically, an enclosing and sealing of the cathode substrate 252 by the separator layer 128 is accomplished by tracing, cutting and shape sealing along a dashed or dotted line 262. The tracing, cutting and shape sealing procedures can be accomplished through, e.g., a laser or shaped thermal sealing machinery. One end of a positive current collector 254 extends or protrudes outward from the dashed line 262.

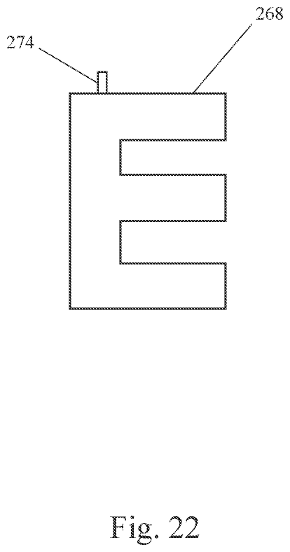

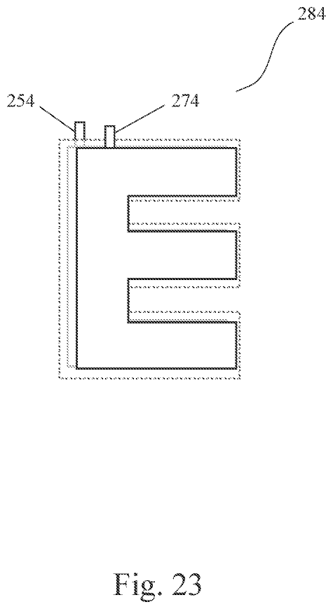

In FIG. 22, an anode substrate 268 of the letter-E pattern is illustrated, with one end of a negative current collector 274 extending or protruding outward therefrom at one end thereof. In FIG. 23, a stacked battery structure 284 of the letter-E pattern is formed by stacking the enclosed cathode substrate 260 as shown in FIG. 21 with the anode substrate 268 as shown in FIG. 22. The stacking is achieved by a direct overlapping of the anode substrate 268 with the enclosed cathode substrate 260. The ends of the positive current collector 254 and negative current collector 274 are respectively positioned on the same side.

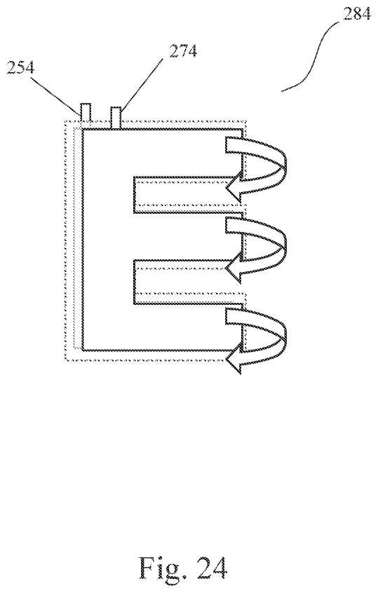

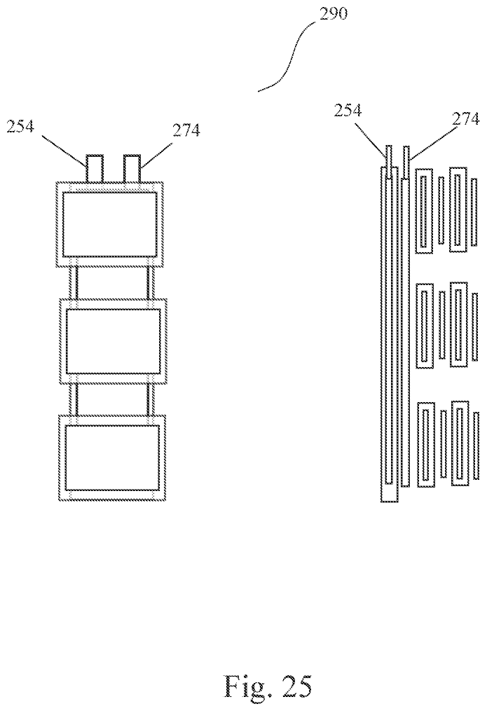

In FIG. 24, the stacked battery structure 284 of the letter-E pattern is subsequently configured by, e.g., folding or bending inward to form a second notched battery structure 290 of uneven thickness as shown in FIG. 25 according to the second exemplary embodiment. More specifically, FIGS. 24 and 25 together illustrate a process at which at least one end or ends on the same side of the stacked battery structure 244 are bent or folded inward to create an uneven thickness within the second notched battery structure 290. As a result, a thinner section of the second notched battery structure 290 provides additional bendability, while a thicker section of the second notched battery structure 290 provides additional charge/discharge capacity. Such uneven thickness is depicted in top and side views of the second notched battery structure 290 as shown in FIG. 25.

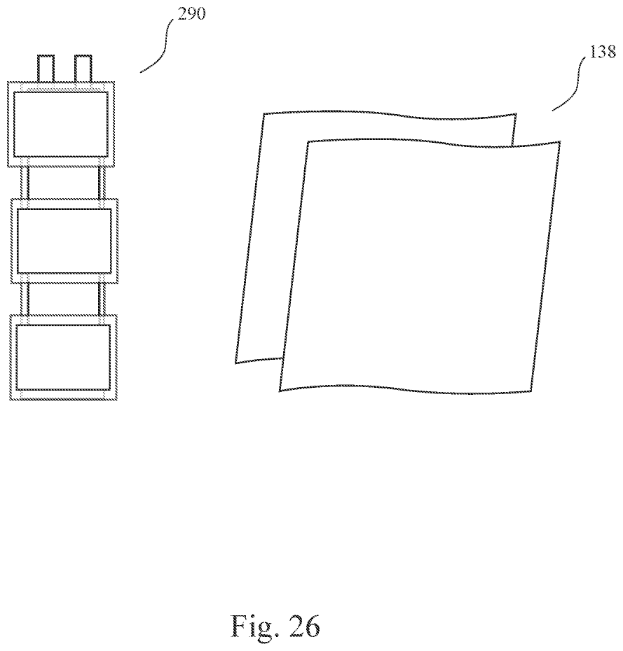

As with the first embodiment, the second notched battery structure 290 in the second embodiment as shown in FIG. 26 is further wrapped and then closed or sealed through the packaging layer 138, which is sufficiently sized to cover the second notched battery structure 290. Particularly, the electrolyte 42 is added or injected prior to the second notched battery structure 290 being completely or effectively sealed or closed by way of, e.g., tracing, cutting and shape sealing procedures.

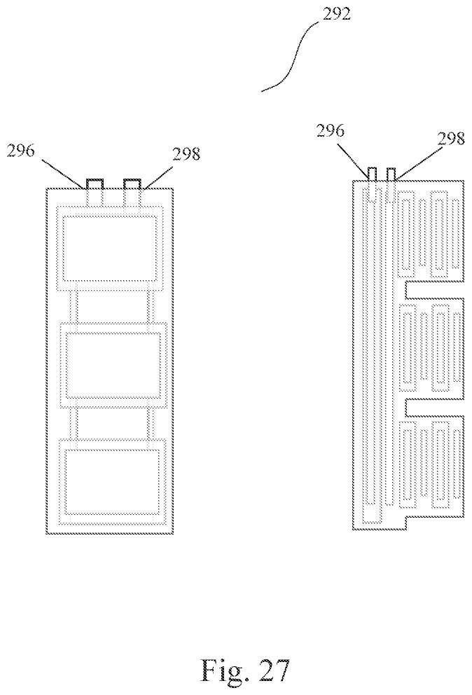

A second battery pouch structure 292 of uneven thickness according to the second embodiment as shown in FIG. 27 is formed by enclosing and sealing of the packaging layer 138 to the second notched battery structure 290. One end of the positive current collector 254 connected to a positive terminal 296, which extends outward therefrom at one end of the second battery pouch structure 290. Similarly, one end of the negative current collector 274 is connected to a negative terminal 298, which extends outward therefrom at the same end of the second battery pouch structure 292.

The advantages of the flexible lithium-ion battery with the free-form structure include reduced battery deterioration, and extended battery life cycle. In particular, the battery unit of the present disclosure can achieve 1000 charge/discharge cycles and maintain over 80% capacity as compared to typical 500 cycles in the industry's conventional battery. The flexible nanofiber-based lithium-ion battery in accordance with the present disclosure can be fabricated to have the following characteristics: Energy Density—450 wH/cm3; Capacity (e.g., watch strap)—Estimate increase from 100 mAh to 150 mAh; Output current—up to 2C; and Bendability—Min bending radius 15 mm (estimate).

Although the present disclosure has been described with reference to specific embodiments, this description is not meant to be construed in a limiting sense. It should be understood that the scope of the present disclosure is not limited to the above-mentioned embodiments, but is limited by the accompanying claims. It is, therefore, contemplated that thee appended claims will cover all modifications that fall within the true scope of the present disclosure. Without departing from the object and spirit of the present disclosure, various modifications to the embodiments are possible, but they remain within the scope of the present disclosure, will be apparent to persons skilled in the art.

What is claimed is:

1. A flexible and rechargeable battery unit, comprising:
a cathode substrate configured in a free-form shape having a positive current collector integrated within positive electrodes;
an anode substrate configured in the free-form shape having a negative current collector integrated within negative electrodes; and
a separator layer for enclosing the cathode substrate or the anode substrate to form an enclosed cathode substrate or an enclosed anode substrate,
wherein the enclosed cathode substrate overlaps with the anode substrate, or the enclosed anode substrate overlaps with the cathode substrate to form a stacked battery structure in the free-form shape.

2. The battery unit according to claim 1, further comprises one or more duplicates of the stacked battery structure that are placed in an overlapping manner with the stacked battery structure to form an enlarged stacked battery structure in the free-form shape.

3. The battery unit according to claim 2, further comprising an enlarged battery pouch structure in the free-form shape formed by wrapping the enlarged stacked battery structure with a packaging layer, wherein the enlarged battery pouch structure is securely closed after an electrolyte is added into the enlarged battery pouch structure.

4. The battery unit according to claim 1, further comprising a battery pouch structure in the free-form shape formed by wrapping the stacked battery structure with a packaging layer, wherein the battery pouch structure is securely closed after an electrolyte is added into the battery pouch structure.

5. The battery unit according to claim 3, wherein a positive terminal that extends outwardly from the battery pouch structure is connected to the positive current collector, and a negative terminal that extends outwardly from the battery pouch structure is connected to the negative current collector.

6. The flexible and rechargeable battery unit of claim 1, further comprising:
a notched battery structure formed by configuring the stacked battery structure to include uneven thickness; and
a battery pouch structure formed by wrapping the notched battery with a packaging layer, wherein the battery pouch structure is securely closed after an electrolyte is added into the battery pouch structure.

7. The battery unit according to claim 6, wherein a positive terminal that extends outwardly from the battery pouch structure is connected to the positive current collector, and a negative terminal that extends outwardly from the battery pouch structure is connected to the negative current collector.

8. The battery unit according to claim 6, wherein one or more thinner sections of the notched battery structure provided additional bendability, and one or more thicker sections of the notched battery structure provides additional charge/discharge capacity.

9. The battery unit according to claim 1, wherein the separator layer is constructed from a nanofiber material.

10. The battery unit according to claim 1, wherein the stacked battery structure of the free-form pattern is bendable in two or more axial directions simultaneously.

11. A method for fabricating a flexible and rechargeable battery unit comprising:
forming a cathode substrate configured in a free-form shape which has a positive current collector placed within positive electrodes;
forming an anode substrate configured in the free-form shape by placing a negative current collector within negative electrodes;
enclosing the cathode substrate or the anode substrate using a separator layer to form an enclosed cathode substrate or an enclosed anode substrate,
wherein the enclosed cathode substrate overlaps with the anode substrate, or the enclosed anode substrate overlaps with the cathode substrate to form a stacked battery structure in the free-form shape.

12. The battery unit according to claim 11, further comprises placing one or more duplicates of the stacked battery structure in an overlapping manner with the stacked battery structure to form an enlarged stacked battery structure in the free-form shape.

13. The method according to claim 12, further comprising forming an enlarged battery pouch structure in the free-form shape by wrapping the enlarged stacked battery structure with a packaging layer, wherein the enlarged battery pouch structure is securely closed after an electrolyte is added into the enlarged battery pouch structure.

14. The method according to claim 11, further comprising forming a battery pouch structure in the free-form shape by wrapping the stacked battery structure with a packaging layer, wherein the battery pouch structure of the first type is securely closed after an electrolyte is added into the battery pouch structure.

15. The method according to claim 13, wherein a positive terminal that extends outwardly from the battery pouch structure of the first type is connected to the positive current collector, and a negative terminal that extends outwardly from the battery pouch structure is connected to the negative current collector.

16. The method according to claim 11 12, further comprising:
forming a notched battery structure by configuring the stacked battery structure to include uneven thickness; and
forming a battery pouch structure of a second type by wrapping the notched battery structure with a packaging layer, wherein the notched battery pouch structure is securely closed after an electrolyte is added into the battery pouch structure of the second type.

17. The method according to claim 16, wherein a positive terminal that extends outwardly from the battery pouch structure is connected to the positive current collector, and a negative terminal that extends outwardly from the battery pouch structure is connected to the negative current collector.

18. The method according to claim 16, wherein one or more thinner sections of the notched battery structure provided additional bendability, and one or more thicker sections of the notched battery structure provides additional charge/discharge capacity.

19. The method according to claim 11, wherein the separator layer is constructed from a nanofiber material.

20. The method according to claim 11, wherein the stacked battery structure of the free-form pattern is bendable in two or more axial directions simultaneously.
